(19) United States
(12) Patent Application Publication
(10) Pub. No.: US 2024/0367751 A1
(43) Pub. Date: Nov. 7, 2024

(54) BICYCLE DEVICE WITH ADJUSTABLE OPERATING STATES

(71) Applicant: DT SWISS INC., Grand Junction, CO (US)

(72) Inventors: Samuel ZBINDEN, Biel (CH); Jérôme HOFFMANN, Port (CH)

(21) Appl. No.: 18/648,925

(22) Filed: Apr. 29, 2024

(30) Foreign Application Priority Data
May 5, 2023 (DE) 102023111795.5

(51) Int. Cl. B62K 25/28; B62K 23/02

(52) U.S. Cl. CPC B62K 25/286; B62K 23/02

(57) ABSTRACT

A bicycle device with a bicycle component with two adjustable, different operating modes and an adjusting member accommodated in the bicycle component for setting the operating modes. The adjusting member includes a valve, which in a first position opens a flow duct wider than in a second position. The adjusting member includes a rotatable adjusting mechanism, which includes different adjusting positions for the two different operating modes, so that further rotation is possible from a first operating mode to a second operating mode in one direction of rotation, and from the second operating mode to the first operating mode in the same direction of rotation.

### BACKGROUND

The present invention relates to a bicycle device with a bicycle component having at least two adjustable, different operating modes. An adjusting member for setting the operating modes is accommodated or incorporated in the bicycle component.

The prior art has disclosed a great variety of bicycles and bicycle components where different operating modes can be set and adjusted. For example, mountain bikes have been disclosed, having suspension forks as bicycle components, where a travelling mode can be adjusted. Thus, the rider can switch the suspension fork to a suitable mode in dependency on the terrain.

The different modes achieve for example a very tight or nearly blocked suspension fork for rides on roads, or a suspension fork with very sensitive response for off-road rides. These travelling modes are usually adjustable either in the top region of the suspension fork, of the fork crown, or by a remote lever attached to the handlebar. The remote lever is disposed such that the hand need not be removed from the handlebar for operating the lever. Pressing the remote lever changes its position, wherein it remains in the pressed position until another return lever is operated.

Suspension forks are not only used in mountain bikes, but they have been employed in so-called gravel bikes for some time. Gravel bikes are racing bicycle types with broad tires, to also enable travelling on graveled paths and in easy terrains. As a rule, gravel bikes also have a curved handlebar, as do racing bicycles. The curved handlebar allows many hand positions. The brake and shift units are configured so as to be within reach of two main grip positions. Typical gravel bikes with suspension forks tend to possess a travelling mode adjustment on the fork crown or at the top end of the fork column. Both options require removal of the hand from the handlebar for adjusting the travelling mode.

Racing bicycle handlebars of gravel bikes have become known which include remote levers for saddle height adjustment, mounted to the handlebar, and within reach of the two main grip positions. The remote lever is realized as a push button, and when actuated, opens a catch mechanism so as to enable saddle height adjustment during rides.

In particular, in sporty riding styles, it is advantageous not only with mountain bikes, but also with gravel bikes for the hand to not require removal from the handlebar for setting or adjusting a travelling mode. However, if the different attachments need to be operable from both the main grip positions, the available room on a handlebar is insufficient.

It is therefore the object of the present invention to provide a bicycle device with a bicycle component having at least two adjustable, different operating modes, wherein controlling and setting or adjusting the operating mode is comparatively simple and adjustment is optionally enabled from different positions.

### SUMMARY

A bicycle device according to the invention comprises at least one bicycle component with (at least) two adjustable, different operating modes, and an adjusting member accommodated, or, in particular, integrated, in the bicycle component for setting the operating modes. The adjusting member preferably comprises a valve, which in a first position opens a flow duct wider than it does in a second position. The adjusting member comprises a rotary adjusting mechanism, which comprises different adjusting positions for each of the (two) different operating modes. The adjusting member may be transferred from a first operating mode to (at least) one second operating mode by rotation in one direction of rotation. To transfer the bicycle component back to the first operating mode, the adjusting mechanism can be rotated further in the same direction of rotation. This means that the adjusting mechanism can be rotated in a specific direction of rotation from a first operating mode to a second operating mode, and that the adjusting mechanism can be rotated further in the same direction of rotation, to switch from the second operating mode back to the first operating mode. The bicycle device according to the invention has many advantages. A considerable advantage of the bicycle device according to the invention consists in that, for changing and switching an operating mode, an adjusting mechanism of an adjusting member on the bicycle component can be rotated. The adjusting mechanism is rotated in the same direction for transferring from the first to a second operating mode, exactly as in transferring from the second operating mode to the first operating mode. This dispenses with the need for rotating the adjusting mechanism in one direction for transferring from the first operating mode to the second operating mode, and rotating the adjusting mechanism reversely for switching back from the second operating mode to the first operating mode. Rotation can simply be continued. This enables a simple, compact control and selection of the operating members.

Alternately, a bicycle device according to the application may comprise a bicycle component and accommodated thereat, an adjusting member, which achieves two different, assigned operating modes of the bicycle component in at least two different adjusting positions. The adjusting member comprises an adjusting mechanism with a tilting mechanism, which when actuated tilts from and to one or the other of the tilting positions. Thus, simple actuation can achieve a shift of the operating mode. Basically, it is also possible to provide for example three positions. For example, a neutral central position and a tilting position to both sides. In particular, the tilting mechanism does always tilt alternatingly, so as to return to the initial state after a certain number of actuations. In this respect this is in analogy to the variant indicated previously, where continuous rotation has the same effect.

Such a bicycle device also has many advantages.

In a preferred specific embodiment of all the bicycle devices, the bicycle component comprises at least one spring unit and/or at least one damper unit. The bicycle component may, in particular, be configured as a suspension fork or a rear wheel damper. It is also possible for the bicycle component to be a seat post. A suspension fork or a rear wheel damper comprise as a rule, at least one spring unit and at least one damper unit, to not only cushion, but also to dampen shocks.

In advantageous specific embodiments, the bicycle component has at least three different, adjustable operating modes. The adjusting member serves to adjust at least part, and preferably all, of the at least three operating modes.

In preferred specific embodiments, a rotary motion of the adjusting mechanism is possible in one direction of rotation (in particular, incremental and preferably indexed). A rotary motion to the one and/or the other direction of rotation is, in particular, impeded for example by a fixing device. A rotary motion may also be blocked in one of the two directions of rotation. Particularly preferably, a rotary motion of the adjusting mechanism is impeded in at least one direction of rotation by a fixing device.

In particular, the adjusting mechanism includes an integrated one-way clutch of a freewheel type. Such a freewheel may for example be realized by interacting toothings or by a ratchet freewheel. In simple configurations, rotary motion is blocked or impeded or braked by a fixing part in one direction of rotation only. It is possible for the fixing part to be configured as a blocking part and to block rotation in one direction of rotation. Alternately it is possible for rotary motion to be (only) decelerated or impeded (stronger and weaker, angle-dependent) in one direction of rotation or in both directions of rotation.

In simple configurations, the fixing device comprises a fixing part, which is biased to a fixing position by a biasing force. In the fixing position, rotation is braked in at least one direction of rotation.

Preferably, the fixing part can be transferred against a biasing force (of a suitable biasing spring) from a fixed position or even a blocked position, to a rotary position, in which the adjusting mechanism is rotatable (more freely). Then, the adjusting mechanism can be rotated further. When the fixing part is configured as a blocking part, a rotary motion in an attempt to reverse the adjusting mechanism is as a rule impeded by the blocking part or the like. Alternately, clicking-in or the like is possible in one direction of rotation or in both directions of rotation. Then, rotation in one direction of rotation or in both directions of rotation can be impeded (for example equally strongly or applying different forces) respectively decelerated (angle-dependent).

These configurations are very advantageous since a defined motion of the adjusting mechanism is provided or even ensured. Movement occurs as a rule in one direction of rotation only, and, in particular, in specific steps or stages. Continuous rotatability (i.e., absent a limit stop) is advantageous.

In preferred specific embodiments, the adjusting member comprises at least one valve, which in a first position opens a flow duct (for example) wider than it does in a second position. Further intermediate positions may be possible. Thus, a flow connection may be wide open in one position via the flow duct, and be entirely blocked in another position. Intermediate positions are likewise possible. Complete opening in one position is preferred. Complete closing in another position is preferred.

In preferred configurations, the valve sets the damper unit to softer damping in one position, and harder damping, in another position. Harder damping is for example suitable on smooth roads and a softer position, for riding off-road. In one position the damper unit can be nearly or entirely blocked. It is conceivable to lower the suspension fork in one position, for example for steep uphill rides.

In preferred configurations, the adjusting mechanism and the valve share one rotation axis. Then, rotating the adjusting mechanism rotates at least part of the valve. Thus, rotating the adjusting mechanism can partially or completely close, or partially or completely open, a flow duct in the valve.

In all the configurations it is particularly preferred for the adjusting mechanism to engage in a plurality of angular positions. Preferably, the adjusting mechanism comprises a rotary wheel with a tooth contour that is (in particular, external and) preferably rounded. The tooth contour interacts with an engaging detent unit. The detent unit may for example be configured as a detent lever, provided for engagement in the gaps between two teeth. Preferably, the detent unit is accommodated spring-loaded and comprises a detent tip or a detent area or range matching the tooth contour. The detent tip may be configured rounded, although it can have an obtuse or acute angle.

The tooth contour and the detent unit may for example directly form the fixing device. Then, a separate fixing device is not necessarily required. A detent unit engaging in the tooth contour may impede rotation in one direction of rotation, or in both directions of rotation. Prohibiting rotary motion in one of the directions of rotation is likewise possible.

The detent unit may comprise, or be configured as, a leaf spring. This allows a simple and inexpensive configuration and mounting.

Alternatively, the detent unit can also be referred to as a snapping unit or a latching unit. A snapping unit may then comprise a snapping-in tip and a snapping-in lever and a latching unit may comprise a latching tip and a latching lever instead of a detent tip and a detent lever.

In preferred configurations, the adjusting mechanism emits a signal in the form of a haptic feedback as another operating mode is reached. This may be realized for example in that, as another operating mode is reached, the detent unit with the matched detent tip engages in the corresponding tooth contour. The clicking-in leads to a haptic feedback, which the user can feel.

It is conceivable to employ for a fixing part, not a (blocking) blocking part, but only a detent unit. The adjusting mechanism is basically functional without blocking in any direction of rotation. This has been tested. The fixing device may comprise a blocking part and/or a detent unit therefor.

In advantageous configurations, the adjusting mechanism comprises an adjusting wheel with an adjusting wheel toothing. The adjusting wheel toothing is, in particular, driven by a drive member having at least one driving tooth. The adjusting wheel can also be referred to as a “handwheel” and the “adjusting wheel toothing” as a “handwheel toothing”.

In simple configurations it is sufficient for one single driving tooth to engage the adjusting wheel toothing as required and to rotate the adjusting wheel for setting another operating mode. It is possible to configure the driving tooth hook-like or in the shape of a pulling hook. At any rate, movement of the driving tooth is transferred to the adjusting wheel toothing.

Preferably, when the drive member performs a pulling motion from the base position (basic position, home position) to an actuating position, the driving tooth rotates the adjusting wheel further (by a specific angle). This enables a defined operation, wherein the actuation of the drive member causes defined rotation of the adjusting wheel.

Preferably, the drive member is biased to the base position. In particular, the drive member is automatically returned from the actuating position to the base position. Preferably, the driving tooth of the drive member is biased to an engaging position by a spring part. This is to provide reliable response to actuation.

In all the configurations it is preferred for the driving tooth to be pivoted away from the adjusting wheel against the force of the spring part when returning the drive member from the actuating position to the base position. This means that in returning, the driving tooth disengages from the adjusting wheel toothing. Thus, movement in returning the drive member is not transferred to the adjusting mechanism.

In the configurations including a spring unit integrated in the bicycle component, the spring force of the spring unit is preferably adjustable. For example, an auxiliary spring may be energized or de-energized for setting a suitable operating mode. To this end, it is preferred for the (effective) spring force of the spring unit to differ in at least two different angular positions of the adjusting mechanism. For example, a second spring unit may be energized or de-energized in parallel or in series.

A control unit with a supporting component and a control unit movable between a rest position and at least one actuating position is preferably provided in all the configurations. Such a control unit may, in particular, be disposed remote from the bicycle component. For example, it is particularly preferred for the control unit to be provided for mounting to the handlebar of a bicycle. In particular, the control unit is mounted to the handlebar, which is then a component of the bicycle device.

Preferably, such a handlebar is configured largely straight, or, particularly preferably, curved as a racing handlebar. The handlebar, in particular, allows ease of operation from at least two different gripping positions.

Preferably, the bicycle device comprises a suspension fork and/or a rear wheel damper as a bicycle component. The adjusting member is received on the bicycle component, and the control unit may be disposed on any place of the bicycle. In particular, the control unit can be disposed on the handlebar of a bicycle. A suspension fork may for example be provided for lowering. Then, one operating mode may be lowered, and one operating mode may be the normal (largely) extended operating mode. An (other) operating mode may show a softer damping, and another operating mode may be a hard damping and/or a blocked damping (lockout).

In advantageous configurations, the operating member is connected with the adjusting mechanism by at least one mechanical connection member such as a control cable or a hydraulic line. In simple configurations, a control cable is employed as a connection member, wherein at one end of the control cable, the connection member is coupled with the drive member and the driving tooth. The connection member comprises, in particular, a Bowden cable and/or a hydraulic line. A plunger or a pin for coupling to the adjusting mechanism may be provided or connected.

Preferably, the adjusting mechanism returns a signal in the form of a haptic feedback via the mechanical connection member to the control unit, as another operating mode is reached. Then, the user can feel it through the lever at the handlebar that another operating mode has been reached. This is advantageous for example in noisy surroundings.

Preferably, the operating member is moved from the rest position to the actuating position for shifting the operating mode. Preferably, the operating member returns to the base position after actuating and changing an adjustment of the bicycle component. For this, a biasing device is, in particular, provided which biases the operating member to the rest position. Thus, a defined positioning of the operating member is always provided (or even ensured). In these configurations, every shifting of the operating mode causes the operating member to move from the rest position to the actuating position. The adjusting mechanism causes successive shifting of the operating modes.

Preferably, repeated (and, in particular, identical) actuation of the operating member from the rest position to the actuating position of the bicycle component causes the successive setting of alternating, different operating modes. In the case of successive actuations, the available operating modes are successively controlled respectively set or switched through.

It is possible and preferred for the bicycle device to comprise, other than a first bicycle component, a second bicycle component accommodating a second adjusting member. The second adjusting member comprises respectively accommodates a second, rotatable adjusting mechanism. It is possible to employ two operating members. However, it is preferred to use one single, shared operating member for controlling two different bicycle components. Then, the operating member is connected with the second adjusting mechanism via a second, mechanical connection member such as a control cable or a hydraulic line. Then, for example moving the operating member in a first direction can control the first bicycle component, while moving the operating member in a second (different) direction controls a second bicycle component.

Preferably, for shifting the operating modes of the second bicycle component, the operating member is moved from the rest position to a second actuating position. The second actuating position differs from the first actuating position.

For shifting the operating modes of the second bicycle component, the operating member is, in particular, moved in a direction running reverse and, in particular, opposite to the direction of movement from the rest position to the first actuating position. Thus, the operating member may for example be pivoted in one direction for changing the operating mode of the first bicycle component, and pivoted in a second direction so as to change the operating mode of the second bicycle component independently of the first bicycle component.

Another bicycle device according to the application comprises at least one bicycle component with (at least) two different, adjustable operating modes, and an adjusting member accommodated on the bicycle component for setting the operating modes. The adjusting member comprises an adjusting mechanism which comprises or provides a different adjusting position for each of the two different operating modes. The adjusting member comprises (at least) one (and, in particular, mechanical) signal generator (and/or sound generator). (Only) As another operating mode is reached, does the signal generator (and/or sound generator) generate a (controlled and perceptible and) defined signal (or defined sound). A separate sound generator and/or signal generator is, in particular, comprised. The signal generator or at least one signal generator may be configured as a sound generator. The signal generator or at least one signal generator may also emit haptic signals.

This bicycle device according to the application also has many advantages. A considerable advantage consists in that the user receives feedback as the user actuates for example the operating member. The user receives a signal and preferably an acoustic and/or a haptic feedback precisely as and when another operating mode is reached. Not before, which avoids misinformation. And not later, so that the user's response is always appropriate.

Particularly preferably, at least one (or all) of the signal generators is/are configured on the adjusting mechanism.

A haptic feedback is likewise possible and preferred, which can preferably be felt in an operating member. Then, the user can immediately feel the feedback.

In simple configurations it is possible to always emit the same signal (for example sound) when shifting to the next operating mode. It is possible and preferred for an additional, different signal (for example sound) to be emitted when the operating member (for example the lever) is released and returns to the rest position. This is an indication that the next actuation can be done.

After emitting a first signal (sound signal and/or haptic signal) as actuating the operating mode achieves a successful shift, a second signal (sound signal and/or haptic signal) is emitted when the operating member (for example the lever) has returned to the rest position (starting position).

Preferably, the signal generator is a mechanical signal generator, mechanically generating (immediately) (at least) one signal (acoustically and/or haptically). It is also possible to electronically transmit a signal and then to convert it, generating a sound, a haptic signal such as vibration, and/or an optical signal.

This means that a signal and preferably a sound is not (necessarily) triggered with actuation but exactly as another operating mode is reached. Thus, the user obtains higher security since he knows at all times the operating mode in which the bicycle component is. This avoids unnecessary multiple actuation, increasing the user's comfort and satisfaction. In case that the actuation—for whatever reason—was unsuccessful, the user does not receive a false signal.

Preferably, the adjusting mechanism is rotatable and is rotated further when transferring from a first operating mode to a second operating mode in one direction of rotation, and when transferring from the second operating mode to the first operating mode, in the same direction of rotation.

In all the configurations it is preferred for the signal generator to generate different, defined signals (and, in particular, sounds) when shifting between different operating modes. Thus, for example when shifting from a first to a second operating mode, the signal generator may generate a first, defined signal (for example a higher sound). When shifting from the second operating mode to another operating mode, a second defined signal (and for example a lower sound) may be generated. Particularly preferably the generated signal (sound) is dependent on the operating mode reached. This means that for example a defined signal (sound, haptic) is assigned to each operating mode. Then the generated signal is not dependent on the operating mode from which shifting takes place but only on the operating mode reached.

For example, the frequency of a generated sound may differ from the frequency of another sound. It is also possible for the intensity (sound volume) or composition of a generated sound to depend on the operating mode reached. Thus, haptic signals may differ accordingly. Also conceivable are, optical signals of different colors, intensities or flashing frequency.

Preferably, a defined signal (in particular, haptic signal or sound) is generated by a signal generator comprising components from a group of components including gear wheels, spring members, leaf springs, bells, clappers and hollow bodies and other sound generators.

In preferred configurations, for example a spring may strike or rub against a component as an operating mode is reached. Various items placed on the object, or hollow bodies, or hollow bodies with various fillings may serve to generate different sound characteristics, so that the user can identify the operating mode reached by the emitted sound.

In advantageous specific embodiments, the or a signal generator may be provided for further auxiliary functions. It is for example possible for the signal generator to also serve as a blocking part, to ensure rotary motion of the adjusting mechanism in one direction only.

In simple configurations, the signal generator (for example sound generator) may at least partially consist of a leaf spring or the like sitting on the outside of a toothing for example of the adjusting wheel. When the adjusting wheel is rotated far enough, the leaf spring may for example deflect into a valley between two teeth of the adjusting wheel toothing, where it hits on the bottom of the “valley”, thus generating a signal (sound) related to the depth and the material quality of the valley and the leaf spring. Different materials and for example different valley depths thus generate different sounds and/or vibrations.

In all the configurations and further developments, a sound generator may be configured, or be referred to, as a signal generator, so that the term “signal generator” may be interchanged with the term “sound generator” throughout the application. A signal generator generates perceptible signals. Such a signal is preferably acoustic and/or haptic. Likewise conceivable are (additional) optical or electric signals.

Preferably, at least one signal generator is comprised. Preferably, an operating member for actuating the adjusting mechanism is comprised which can be transferred from a rest position to an actuating position for actuating. The operating member may be configured as a push button or operating lever or the like, and is, in particular, mounted to the handlebar. Preferably, the (or another) signal generator emits at least one signal, as the operating member (once again, following actuation) reaches the rest position.

Such an (acoustic or haptic) signal is preferably emitted independently of the result of an actuation. Thus, the user knows from the signal that he may actuate once again, for example if shifting has not worked, or if the user wishes to shift to another, different operating mode. This is different from a signal after reaching a new operating mode. This is why the corresponding signals are preferably clearly distinguished. Thus, as the user reaches a new operating mode (suspension fork on lockout) he perceives a first signal. To this end, the user had actuated the operating member. After reaching the new operating mode, a (first) signal type is emitted. As the operating member, for example an operating button or an operating lever, returns to the rest position, a (second) signal type is emitted. Then, the user knows that he can actuate the operating member again as required. This may be helpful for example—but not only—if the operating member is pivotable in two directions for controlling two separate bicycle components.

In all the configurations, the invention is particularly preferably employed in vehicles and, in particular, bicycles which in normal and regular proper use are at least partially muscle-powered. The invention is, in particular, used in sports bicycles.

Further advantages and features of the present invention can be taken from the exemplary embodiments which will be discussed below with reference to the enclosed figures.

### BRIEF DESCRIPTION OF THE DRAWINGS

The figures show in:

FIG. 1 a schematic illustration of a gravel bike;

FIG. 2 a schematic illustration of a mountain bike;

FIG. 3 a schematic front view of a suspension fork for a bicycle according to FIG. 1 or 2;

FIG. 4 a schematic, enlarged side view of a detail of the handlebar of the bicycle according to FIG. 1;

FIG. 5 three enlarged details of the suspension fork according to FIG. 3;

FIGS. 6a-6d various enlarged cross sections of the adjusting member of a bicycle component according to the invention; and

FIGS. 7a-7d further views of the adjusting member according to the FIGS. 6a-6d.

### DETAILED DESCRIPTION

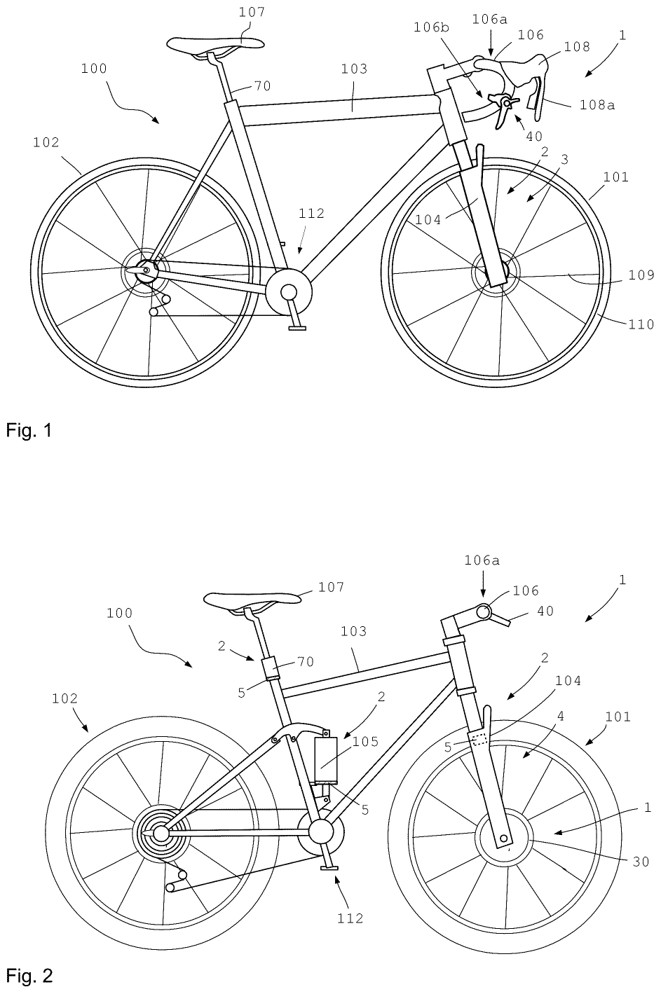

FIGS. 1 and 2 show a mountain bike and a gravel-bicycle or racing bicycle 100 respectively, which are equipped with bicycle devices 1 according to the invention. The mountain bike or racing bicycle 100 is provided with a front wheel 101 and a rear wheel 102.

The two wheels 101, 102 are provided with spokes 109. A sprocket device 111 is provided. Basically, conventional caliper brakes or other brakes such as for example disk brakes may be provided.

The bicycles 100 are each provided with a frame 103, a handlebar 106, a saddle 107, a fork or suspension fork 104 respectively, and in the case of the mountain bike or optionally a gravel bicycle (gravel bike), a rear wheel damper 105 may be provided. A pedal crank 112 with pedals serves for driving. Optionally the pedal crank 112 and/or the wheels may be provided with an electrical auxiliary drive. The hub of the wheels may be attached to the frame by means of a clamping mechanism such as a through axle or a quick release.

The two bicycles in the FIGS. 1 and 2 each show a suspension fork 104 as a bicycle component 2. The operating modes 3, 4 of the bicycle components 2 of the two bicycles 100 are adjustable. To this end, each of the two bicycles 100 is provided with a control unit 40 on the handlebar 106, with which to change the operating mode of the bicycle components 2.

As FIG. 1 shows, a curved handlebar or racing handlebar 106 is used, with the control unit 40 mounted in the lower, curved region. This results in the fact that the control unit 40 of the racing bicycle or gravel bike from FIG. 1 can be comfortably operated from the two main gripping positions at the brake grip 108 and the lower region. The control unit 40 can be operated both from the gripping position 106a and from the gripping position 106b. The brake lever 108a on the brake grip 108 can also be operated from these positions. Optionally it is possible to also use the control unit 40 for setting a height-adjustable or lowerable seat post 70.

The bicycle components 2 each (directly) accommodate an adjustment device 5, which can be adjusted by the operating lever disposed remotely, on the handlebar 106.

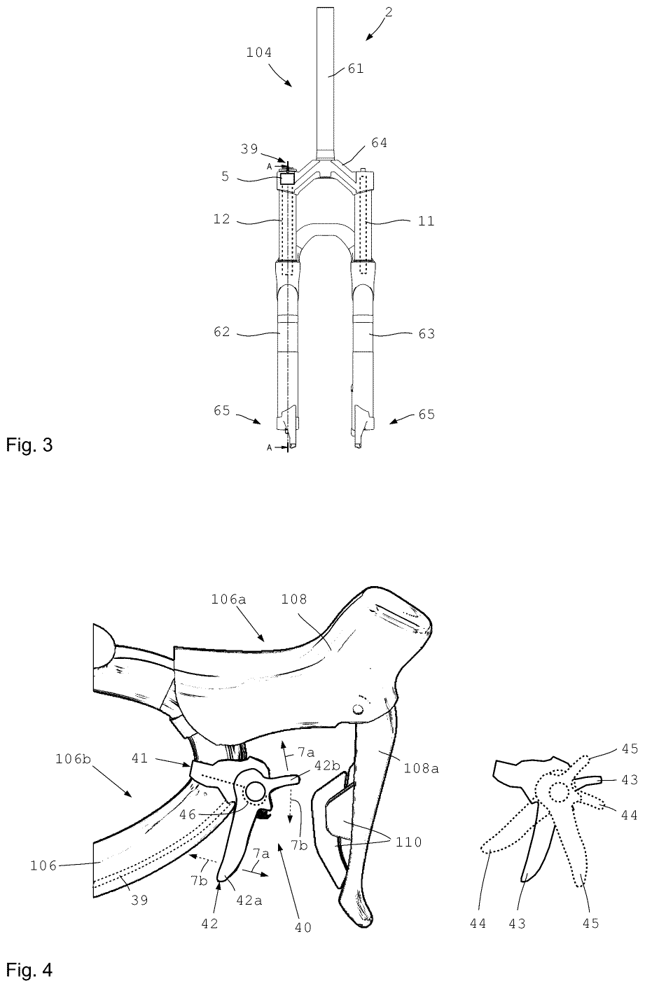

FIG. 3 shows a schematic front view of a suspension fork 104 of a bicycle, as it can be used in the FIGS. 1 and 2. The suspension fork 104 has a fork column 61 and two telescopic fork legs 62, 63. A dropout 65 is provided on each of the lower ends. On top, the two fork legs 62 and 63 are connected by a fork crown 64. As a rule, one of the fork legs accommodates a spring unit 11 and the other of the fork legs, a damper unit 12. It is also possible for the spring unit 11 and the damper unit 12 to be accommodated together in one fork leg 62, 63.

FIG. 3 schematically indicates an adjusting member 5 in the upper region of a fork leg 62. The adjusting member 5 is connected with the control unit 40 on the handlebar 106 by a mechanical connection member 39. The connection member 39 may comprise the actual connecting line (Bowden cable, hydraulic line) and for example a clapper 39a or the like coupled thereto. It is also possible for example for a Bowden cable to directly assume the function, so as to eliminate the need for a clapper 39a or the like. Actuating the control unit 40 operates the connection member 39 and accordingly adjusts the setting of the adjusting member 5.

FIG. 4 shows an enlarged side view of the handlebar 106 with the brake grip 108 and the control unit 40 accommodated on the racing handlebar. The control unit 40 has a supporting component 41 which is shown directly attached to the handlebar 106. The supporting component 41 receives the operating member 42, which can be pivoted in different positions. The figure shows the rest position 43 and first and second actuating positions 44, 45, where the operating member 42 is pivoted in one or the other pivoting direction. For better comprehensibility, the control cables as the connection members 39 are not shown.

In many cases, the connection member 39 is a Bowden cable and not directly visible in the drawing, since it is guided in or on or near the handlebar. This is why the connection member 39 is illustrated in broken lines.

It can be clearly seen that the operating member 42 offers ease of operation both from the gripping position 106a and from the gripping position 106b, allowing pivoting in two directions of rotation 7a, 7b. Depending on the gripping position, the user grips and pivots one end 42a or the other end 42b of the operating member 42, with a finger. The invention enables a compact structure, wherein a control lever can adjust two different bicycle components 2 or their operating modes 3, 4, respectively.

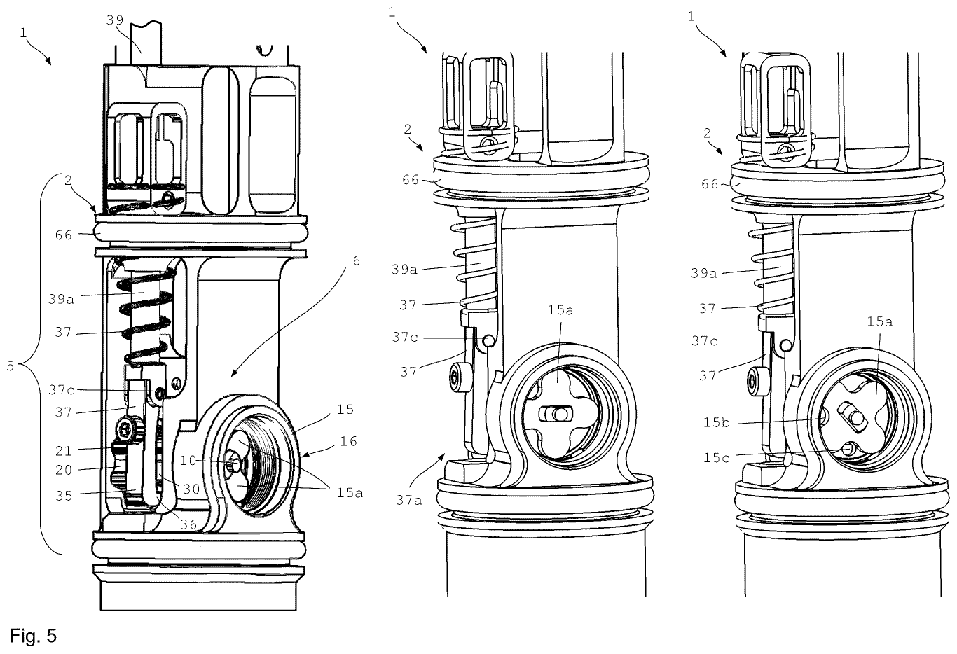

FIG. 5 shows three enlarged details of the top region of the suspension fork of FIG. 3 in three slightly different positions, with the outer fork leg omitted to allow a view of the inner structure. The detail shown is accommodated in the top region of the fork leg and outwardly sealed by seals 66. The details shown accommodate the adjusting member 5. The connection member 39, which can be partially seen in the interior of the adjusting member 5, is supplied from above. A biasing device 37 biases the connection member 39 to the base position 37a illustrated on the left in FIG. 5.

The end of the connection member 39 is presently provided with a drive member 35 which is pivotable around the pivot axis 37c by a driving tooth 35. The driving tooth 36 may also be referred to as a driving hook. At any rate, a hook or driving tooth 36 protrudes from the drive member 35, for rotating the adjusting wheel 30, not shown in detail, upon actuation.

The adjusting member 5 comprises an adjusting mechanism 6 with a central rotation axis 9. The rotary wheel 20 is rotatably accommodated around the rotation axis 9. The adjusting wheel 30 is likewise rotatably disposed around the rotation axis 9. Here, the rotary wheel 20, the adjusting wheel 30 and the vanes 15a of the valve 15 rotate in synchrony and around the rotation axis 9. The rotary wheel 20 and the adjusting wheel 30 may be configured integrally.

The adjusting member 5 is illustrated on the left in FIG. 5 in the base position 37a. The operating mode 3 is set by way of example. In this operating mode, for example a damper unit 12 can be set so as to achieve increased damping. This position can be seen on the right in FIG. 5, where the valve openings 15b and 15c are not covered and closed by the vanes 15a, but completely open, thus providing a flow connection.

In the center image of FIG. 5, the vanes are in such a rotary position that the valve openings 15b and 15c are completely closed by the vanes 15a, so as to prohibit flow. In addition, a rotary position is possible in which the one or two valve opening(s) 15b, 15c are partially closed. Also possible is a position where further—or only—larger or smaller valve openings are unblocked or closed, to enable further settings.

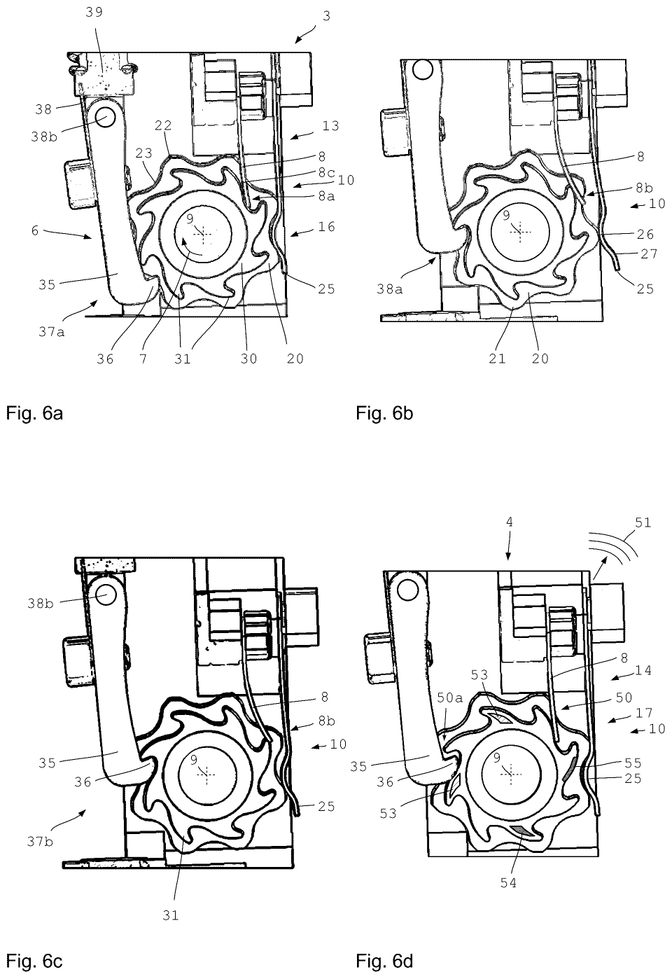

FIGS. 6a to 6d illustrate various enlarged side views of the adjusting mechanism 6 of the adjusting member 5. Each of the connection members 39 is supplied in the top left region. At its end, the connection member 39 is connected with the drive member 35, which is accommodated for pivoting around a pivot axis 38b. The (smaller) adjusting wheel 30 with the adjusting wheel toothing 31 serving for driving and the rotary wheel 20 are disposed for rotation around the central rotation axis 9. The rotary wheel 20 is provided with an outer tooth contour 21 with rounded teeth, forming “hills” 22 and in-between, “valleys” 23.

A detent unit 25, presently configured as a leaf spring, rests against the tooth run of the tooth contour 21 with a detent tip 26, in an approximate form-fit. In this place, a form closure forms, which however allows further rotation in the direction of rotation 7 using little force. This detent unit 25 together with the tooth contour 21 may form the fixing device 10 and ensure rotation in one direction of rotation.

With further rotation, the detent unit 25 is displaced outwardly, so that a slightly increased resistance can be felt in rotating. When the “hill 22” is overcome, the detent tip 26 is automatically set in the next valley 23, so that the user can feel a haptic feedback.

The sequence in a rotary motion from a first position or angular position 16 to a second position respectively angular position 17 is shown in the FIGS. 6a, 6b, 6c and 6d.

Shown is, the run with actuating the operating member 42, wherein the drive member 35 is pulled upwardly and the driving tooth 36 engages in the adjusting wheel toothing 31 of the adjusting wheel 30 and, due to the movement of the drive member 35, rotates further by a specific angle. The dimensions are such that with every actuation of the operating member 42, the adjusting wheel 30 is rotated further by an angle of 45°. On the whole, eight angular positions result, in which the detent unit 25 engages with the detent tip 26. In the exemplary embodiment shown, the operating modes 3, 4 alternate. It is also possible for three or four or more different operating modes to alternate successively. At any rate, the adjusting mechanism 6 is disposed for continuous rotation, so that in this case, every actuation of the operating member 42 rotates the adjusting wheel 30 further by 45°.

As FIG. 6a shows, in the base position 37, the driving tooth 36 of the drive member 35 is disengaged from the teeth 31 of the adjusting wheel toothing. Actuating the operating member 42 causes the driving tooth 36 to engage in the adjusting wheel toothing and to rotate the adjusting wheel 30 further.

Resetting the drive member 35 makes the drive member 35 pivot outwardly around the rotation axis 38b, so as to leave the operating mode unchanged.

FIG. 6d shows additional acoustic units 53-55, which can influence or generate the emitted sounds 51.

In a simple configuration, the fixing part 8 does not only serve to prohibit reverse rotation of the adjusting wheel 30, but also serves as a signal generator 50. The signal generator 50 shown comprises a leaf spring, which in the rotating process such as in the illustration of FIG. 6c, makes a transition from the biased state illustrated in FIG. 6c to an unbiased state, wherein the bottom end of the leaf spring hits the bottom of the adjusting wheel between two toothings of the adjusting wheel toothing 31. Thus, in simple configurations, each shifting process always generates the same signal, presently a sound. The signal may comprise a sound. The signal may also be haptically returned to the operating member, where the user can directly feel it in his fingers. The signal generator 50 works, in particular, mechanically and is preferably incorporated in the adjusting member 5.

It is also possible to assign different signals and/or sounds 51 to different operating modes 3, 4. To this end, for example the adjusting wheel 30 may have appropriate hollow spaces or filled hollow spaces or items placed on top, of other materials, so as to influence the acoustic or haptic feedback accordingly. Generating or triggering electric signals is likewise possible, used for remote processing and triggering of optical or acoustic signals.

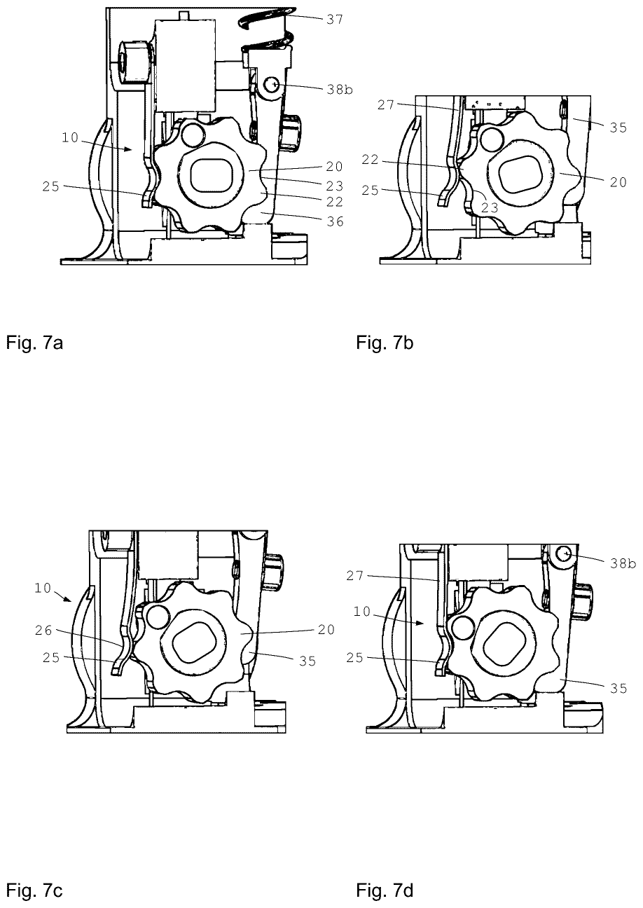

The FIGS. 7a to 7d show schematic, enlarged views of the adjusting mechanism 6 of the adjusting member 5 from the opposite side, thus from the side not accessible from the FIGS. 6a to 6d The detent unit 25 with the detent tip 26 can be clearly seen, which rests form-fit against the adjusting wheel 30 in FIG. 7.

In simple configurations, the detent unit 25 together with the tooth contour 21 directly serves as a fixing device 10. The adjacent detent unit 25 in a valley 23 firstly decelerates (angle-dependently) a rotary motion of the rotary wheel 20 (and thus also rotation of the rotatable part of the valve 15), until the hill 22 is reached and the clickstop is lifted. This mechanism may ensure a defined rotation of the adjusting mechanism on its own. In particular, if a mechanical signal of the hitting fixing part 8 can be dispensed with after shifting the operating mode. Alternately, the signal may be generated electronically or otherwise mechanically.

As can be seen in the FIGS. 7a, 7b, 7c and 7d, the detent unit 25 is firstly displaced outwardly, before it once again comes into a form-fit against the tooth contour 21 in FIG. 7d.

On the whole, the invention provides an advantageous bicycle device 1, which employs a push button-operating member for shifting the operating mode of a bicycle component 2. For example, travelling modes of a suspension fork can be readily shifted from the handlebar. The adjusting mechanism is realized so that with every further actuation of the control unit, the operating member returns to the initial position and is readily accessible and operational for another actuation. The adjusting mechanism is realized such that it shifts to the next operating mode with every further actuation.

Other than actuating for example a suspension fork, it is also possible to control a lowerable seat post or to incorporate a function for lowering a seat post. It is possible, with one single operating member, to control both an adjustment of the travelling mode of a suspension fork, and of another bicycle component 2.

Thus, shifting is possible from a neutral central position for example in one direction of rotation, while in the other rotary or pivoting direction, the seat post height is adjusted. To this end, two connection members or cables may be connected with the operating member 42 or the control unit 40, wherein one is pulled when the lever rotates clockwise, and the other, when it rotates in the opposite direction.

When setting the operating mode of a damper or a suspension fork, a valve may for example be partially or entirely opened or closed. With every actuation of the operating member 42, each of the operating modes of the pertaining bicycle component 2 is then switched through. The principle is basically an analogy to a ball-point pen where the refill is pushed out for writing or with the next push, retracted again. Accordingly, a number of operating modes may be switched through in analogy.

In all the configurations it is also possible to use ratchet disks or the like as drive members. A detent system is also possible. It is likewise conceivable to attach a control cable immediately onto a disk. A rotation or extension spring may also be used as a return spring.

In all the configurations it is particularly preferred to decouple the valve from the connection member 39 in a damper unit 12. This may be done in that, when actuating the operating member 42, the user must overcome with his fingers or with his fingers' force, the friction of the control cable and the friction of all the seals and the force of the return spring. The invention provides that the return spring need not be designed as strongly for returns after actuating. The return spring must only take over the static friction of the cable, not the forceful static friction of the valve.

Another advantage is that the user receives a signal for example in the form of haptic and/or acoustic feedback, if shifting the operating mode has been successful. This is advantageous, in particular, since the feedback is directly coupled for example to the valve position, so that the feedback of success is received only if the operating mode has actually been successfully shifted.

Returning the operating member 42 to the rest position 43 also triggers a (another and distinguishable) signal, so that the user knows that he can once again actuate the operating member 42 as required. This signal is generated by (another and presently) the (second) signal generator 50a. The signal generator 50a shown is formed by the adjusting wheel 30 (and, in particular, the adjusting wheel toothing 31) and the drive member 35 (and, in particular, the driving tooth 36). When returning the operating member 42 to the rest position 43, the drive member 35 (driving tooth 36) preferably hits on the adjusting wheel 30, as it jumps back over a tooth of the adjusting wheel toothing 31. This generates a signal and preferably a clearly perceptible sound, which the user can perceive and distinguish.

While particular embodiments of the present bicycle device with adjustable operating modes have been described herein, it will be appreciated by those skilled in the art that changes and modifications may be made thereto without departing from the invention in its broader aspects and as set forth in the following claims.

List of reference numerals:

| | |
|---|---|
| 1 | bicycle device |
| 2 | bicycle component |
| 3, 4 | operating mode |
| 5 | adjusting member |
| 6 | adjusting mechanism |
| 7 | direction of rotation |
| 7a, 7b | direction of rotation |
| 8 | fixing part |
| 8a | fixing position |
| 8b | rotary position |
| 8c | fixing spring |
| 9 | rotation axis |
| 10 | fixing device |
| 11 | spring unit |
| 12 | damper unit |
| 13 | adjusting position |
| 14 | adjusting position |
| 15 | valve |
| 15a | vane, valve vane |
| 15b, c | valve opening |
| 16, 17 | position, angular position |
| 20 | rotary disk |
| 21 | tooth contour |
| 22 | hill |
| 23 | valley |
| 25 | detent unit |
| 26 | detent tip |
| 27 | leaf spring |
| 30 | adjusting wheel |
| 31 | adjusting wheel toothing |
| 35 | drive member |
| 36 | driving tooth |
| 37 | biasing device |
| 37a | base position of 36 |
| 37b | actuating position |
| 37c | pivot axis |
| 38 | spring part |
| 38a | engaging position |
| 38b | pivot axis |
| 39 | connecting member |
| 39a | clapper |
| 40 | control unit |
| 41 | supporting component |
| 42 | control |
| 42a, b | end |
| 43 | rest position |
| 44 | 1st actuating position |
| 45 | 2nd actuating position |
| 46 | biasing device |
| 50, 50a | signal generator |
| 51 | signal, sound |
| 53-55 | acoustic unit |
| 61 | fork column |
| 62, 63 | fork leg |
| 64 | fork crown |
| 65 | dropout |
| 66 | seal |
| 70 | lowerable seat post |
| 100 | bicycle |
| 101 | wheel, front wheel |
| 102 | wheel, rear wheel |
| 103 | frame |
| 104 | fork, suspension fork |
| 105 | rear wheel damper |
| 106 | handlebar, handle |
| 106a | gripping position |
| 106b | gripping position |
| 107 | saddle |
| 108 | brake grip |
| 108a | brake lever |
| 109 | spoke |
| 110 | shift lever |
| 111 | sprocket assembly |
| 112 | pedal crank |

1. A bicycle device with a bicycle component with two adjustable, different operating modes and an adjusting member accommodated in the bicycle component for setting the operating modes,
wherein the adjusting member comprises a valve, which opens a flow duct in a first position wider than in a second position; and
the adjusting member comprises a rotary adjusting mechanism, which includes different adjusting positions for the different operating modes, so that further rotation is possible from a first operating mode to a second operating mode in one direction of rotation, and from the second operating mode to the first operating mode, in the same direction of rotation.

2. The bicycle device according to claim 1, wherein the bicycle component comprises at least one unit from a group of units including a spring unit and a damper unit.

3. The bicycle device according to claim 1, wherein a rotary motion of the adjusting mechanism is impeded in at least one direction of rotation by a fixing device, and wherein the fixing device comprises a fixing part, which is biased into a fixing position by a biasing force.

4. The bicycle device according to claim 2, wherein the valve of the adjusting member sets the damper unit to softer damping in one position, and to harder damping, in another position.

5. The bicycle device according to claim 1, wherein the adjusting mechanism and the valve share one rotation axis, wherein the adjusting mechanism engages into a plurality of angular positions.

6. The bicycle device according to claim 1, wherein the adjusting mechanism comprises a rotary wheel with a tooth contour, which interacts with a detent unit engaging the tooth contour,
and wherein the detent unit is accommodated spring-loaded and comprises a detent tip matching the tooth contour.

7. The bicycle device according to claim 1, wherein the adjusting mechanism returns a signal as a feedback, as another operating mode is reached.

8. The bicycle device according to claim 1, wherein the adjusting mechanism comprises an adjusting wheel, which includes an adjusting wheel toothing,
and wherein a drive member drives the adjusting wheel toothing with at least one driving tooth,
and wherein, when the drive member performs a pulling motion from the base position to an actuating position, the driving tooth rotates the adjusting wheel.

9. The bicycle device according to claim 8, wherein the drive member is biased to the base position by a biasing device, and is automatically returned from the actuating position to the base position,
and wherein the driving tooth of the drive member is biased to an engaging position by a spring part,
and wherein, as the drive member is returned from the actuating position to the base position, the driving tooth is pivoted away from the adjusting wheel against the force of the spring part.

10. The bicycle device according to claim 2, wherein the spring force of the spring unit is adjustable,
and wherein the spring force of the spring unit differs in at least two different angular positions of the adjusting mechanism.

11. The bicycle device according to claim 1, comprising a handlebar and a control unit with a supporting component, and an operating member movable between a rest position and at least one actuating position, wherein the control unit is mounted to the handlebar, wherein the operating member is connected with the adjusting mechanism via at least one mechanical connection member such as a control cable or a hydraulic line,
wherein the connection member is coupled with the drive member and the driving tooth.

12. The bicycle device according to claim 11, wherein the handlebar is configured largely straight or curved as a racing handlebar, and allows operation from at least two different gripping positions.

13. The bicycle device according to claim 11, comprising a suspension fork and/or a rear wheel damper as a bicycle component, wherein the adjusting member is accommodated on the bicycle component, and wherein the control unit can be disposed on the handlebar of a bicycle.

14. The bicycle device according to claim 1, wherein the operating member is moved from the rest position to the actuating position for shifting the operating mode,
and wherein repeated actuation of the operating member from the rest position to the actuating position of the bicycle component causes the successive setting of alternating different operating modes.

15. The bicycle device according to claim 1, comprising a second bicycle component with a second adjusting member accommodated thereat, with a second rotatable adjusting mechanism accommodated thereat, wherein the operating member is connected with the second adjusting mechanism via a second, mechanical connection member such as a control cable or a hydraulic line,
and wherein, for shifting operating modes of the second bicycle component, the operating member is moved from the rest position to a second actuating position,
and wherein, for shifting operating modes of the second bicycle component, the operating member is moved in a direction which runs reverse to the direction of movement from the rest position to the first actuating position.

16. A bicycle device with a bicycle component having two different, adjustable operating modes and an adjusting member accommodated in the bicycle component for setting the operating modes,
the adjusting member comprises an adjusting mechanism, which provides a different adjusting position for each of the two different operating modes,
and the adjusting member comprises at least one signal generator, and that as another operating mode is reached, the signal generator generates a controlled, perceptible and defined signal.

17. The bicycle device according to claim 16, wherein the adjusting mechanism is rotatable, and wherein further rotation from a first operating mode to a second operating mode is possible in one direction of rotation, and from the second operating mode to the first operating mode in the same direction of rotation, and wherein at least one signal generator is configured on the adjusting mechanism,
and wherein the signal generator impedes or blocks one direction of rotation of an adjusting wheel, so as to establish a one-way clutch.

18. The bicycle device according to claim 16, wherein when shifting different operating modes, the signal generator generates different, defined signals, and wherein, in shifting from a first to a second operating mode, the signal generator generates a first defined signal, and in shifting from the second operating mode to another operating mode, generates a second defined signal.

19. The bicycle device according to claim 16, wherein at least one defined signal is generated by a signal generator comprising components from a group of components including gear wheels, spring members, leaf springs, bells, clappers, and hollow bodies,
and wherein the signal generator emits signals from a group of signals including acoustic signals and haptic signals.

20. The bicycle device according to claim 16, wherein an operating member for actuating is comprised, which for actuating can be transferred from a rest position to an actuating position, and wherein another signal generator is comprised, which emits a signal, as the operating lever reaches the rest position.
